(19) United States
(12) Patent Application Publication
(10) Pub. No.: US 2013/0257309 A1
(43) Pub. Date: Oct. 3, 2013

(54) LIGHT EMITTING APPARATUS AND ITS DRIVING METHOD

(71) Applicant: CANON KABUSHIKI KAISHA, Tokyo (JP)

(72) Inventor: Kouji Ikeda, Tokyo (JP)

(73) Assignee: CANON KABUSHIKI KAISHA, Tokyo (JP)

(21) Appl. No.: 13/771,154

(22) Filed: Feb. 20, 2013

(30) Foreign Application Priority Data
Mar. 28, 2012 (JP) 2012-073919

(51) Int. Cl. H05B 33/08

(52) U.S. Cl. CPC H05B 33/08
USPC 315/240

(57) ABSTRACT

A light emitting apparatus wherein, after setting a voltage of a light emitting luminance into a gate of the driving transistor, until setting a light emission controlling transistor at an electrically conducting state, a control signal changing toward a voltage of an opposite electrode of the light emitting element is supplied to the other terminal of the capacitor constructed such that an electro-conductive layer supplied with the control signal and a semiconductor layer forming the terminal of the driving transistor at the side of the light emitting element, a semiconductor layer forming a terminal of a transistor different from the driving transistor and connected to the terminal of the driving transistor at the side of the light emitting element, or an electro-conductive layer connected to the terminal of the driving transistor at the side of the light emitting element are formed so as to face through an insulating layer.

### BACKGROUND OF THE INVENTION

1. Field of the Invention

The present invention relates to a light emitting apparatus having a light emitting element and a driving method of the light emitting apparatus and, more particularly, to a light emitting apparatus for controlling a light emission of an organic electroluminescence (EL) element as a current controlling element and a driving method of the light emitting apparatus.

2. Description of the Related Art

As a driving circuit for driving an organic EL (hereinbelow, simply referred to as “EL”), there is a driving circuit having such a construction that a data voltage according to gradation data is supplied to a gate of a driving transistor and a current according to the data voltage is supplied to the EL connected to a source or a drain of the driving transistor. According to the light emitting apparatus using the EL as a light emitting element of such a driving circuit, a black luminance can be set to zero in principle and an infinite contrast can be realized. However, when the source or drain of the driving transistor has a parasitic capacitor, if electric charges charged in the parasitic capacitor flow into the EL, a current which is not concerned with the gradation data flows into the EL and a light emission occurs, so that the contrast deteriorates. For example, when a transistor is connected to the drain of the driving transistor, the parasitic capacitance occurs by a capacitance between a gate and a drain (or source) of the transistor or a crossing of wirings.

As a countermeasure against such a deterioration in contrast as mentioned above, Japanese Patent Application Laid-Open No. 2010-262251 discloses such a driving circuit that a transistor for supplying electric charges in a parasitic capacitor connected to a drain of a driving transistor to a reference voltage is provided, thereby preventing that the unnecessary electric charges accumulated in the parasitic capacitor flow into an EL.

However, according to Japanese Patent Application Laid-Open No. 2010-262251, since a transistor which connects a dedicated reference voltage line and the driving circuit and a controlling wiring of such a transistor are necessary in order to pull out the unnecessary electric charges, and a microminiaturization of the light emitting apparatus is difficult due to an increase in number of component parts. Therefore, the technique disclosed in Japanese Patent Application Laid-Open No. 2010-262251 is not suitable in the case where the microminiaturization of the light emitting apparatus is required.

### SUMMARY OF THE INVENTION

It is an aspect of the invention to provide a microminiaturized light emitting apparatus which can prevent a light emission of an EL that is caused by unnecessary electric charges accumulated in a parasitic capacitor and a driving method of the light emitting apparatus.

According to an aspect of the present invention, a light emitting apparatus comprises: a light emitting element having first and second electrodes, and emitting light by allowing a current to flow between the first and second electrodes; a driving transistor for supplying the current to the first electrode; a light emission controlling transistor arranged between the driving transistor and the first electrode, for controlling an electrical conduction between the driving transistor and the first electrode; and a capacitor having one terminal connected to a terminal of the driving transistor at a side of the light emitting element, wherein, during a period after setting a voltage to be applied to a gate of the driving transistor according to a light emitting luminance of the light emitting element, until setting the light emission controlling transistor at an electrically conducting state, the other terminal of the capacitor is supplied with a control signal of which a voltage changes toward a voltage of the second electrode, and the capacitor is constructed in such a manner that an electro-conductive layer supplied with the control signal and one of a semiconductor layer forming the terminal of the driving transistor at the side of the light emitting element, a semiconductor layer forming a terminal of a transistor different from the driving transistor and connected to the terminal of the driving transistor at the side of the light emitting element, and an electro-conductive layer connected to the terminal of the driving transistor at the side of the light emitting element are formed so as to face through an insulating layer.

According to another aspect of the present invention, a driving method of a light emitting apparatus comprises: a light emitting element having first and second electrodes, and emitting light by allowing a current to flow between the first and second electrodes; a driving transistor for supplying the current to the first electrode; a light emission controlling transistor arranged between the driving transistor and the first electrode, for controlling an electrical conduction between the driving transistor and the first electrode; and a capacitor having one terminal connected to a terminal of the driving transistor at a side of the light emitting element, wherein the method comprises: a first step of setting a voltage to be applied to a gate of the driving transistor according to a light emitting luminance of the light emitting element; a second step of setting the light emission controlling transistor at an electrically conducting state; and, after the first step until a start of the second step, supplying the other terminal of the capacitor with a control signal of which a voltage changes toward a voltage of the second electrode.

According to the invention, by changing the control signal through the capacitor between the driving transistor and the control signal line, the electric charges charged in the parasitic capacitor at the node (terminal) of the driving transistor at a side of the light emitting element can be moved to the capacitor. Therefore, the voltage of the node is lower than the voltage for initiating the light emission of the light emitting element and such a situation that the electric charges in the parasitic capacitor flow into the light emitting element can be prevented. Thereby, a luminance for a black level can be reduced into zero, and the high contrast can be realized. If such a capacitor is used, the number of controlling wirings can be reduced to a value smaller than that in the case of such a construction that the inflow of the electric charges in the parasitic capacitor is prevented by using the transistor. Consequently, the light emitting apparatus can be microminiaturized.

Further features of the present invention will become apparent from the following description of exemplary embodiments with reference to the attached drawings.

### BRIEF DESCRIPTION OF THE DRAWINGS

FIG. 1 is a diagram illustrating a driving circuit of a displaying apparatus according to an embodiment of the invention.

FIG. 2 is a timing chart showing the operation of the driving circuit in FIG. 1.

FIGS. 3A, 3B, 3C and 3D are schematic diagrams illustrating an example of forming a capacitor.

FIG. 4 is a diagram illustrating a driving circuit in the embodiment 1.

FIG. 5 is a timing chart showing the operation of the driving circuit in the embodiment 1.

FIGS. 6A, 6B and 6C are schematic diagrams illustrating an example of forming a capacitor in the embodiment 1.

FIG. 7 is a schematic diagram illustrating a cross section taken along the line A-B of the capacitor in FIG. 6C.

FIG. 8 is a diagram illustrating a driving circuit in the embodiment 2.

FIG. 9 is a timing chart showing the operation of the driving circuit in the embodiment 2.

FIGS. 10A, 10B and 10C are schematic diagrams illustrating an example of forming a capacitor in the embodiment 2.

FIG. 11 is a block diagram illustrating a whole construction of a digital still camera system according to an exemplary embodiment of a light emitting apparatus of the invention.

### DESCRIPTION OF THE EMBODIMENTS

Exemplary embodiments for embodying a light emitting apparatus of the invention will be specifically described hereinbelow with reference to the drawings. Although the invention is desirably used in a light emitting apparatus for controlling a light-on of an EL, it can be also applied to a light emitting apparatus for controlling a light-on of another light emitting element such as inorganic EL, LED, or the like besides the EL.

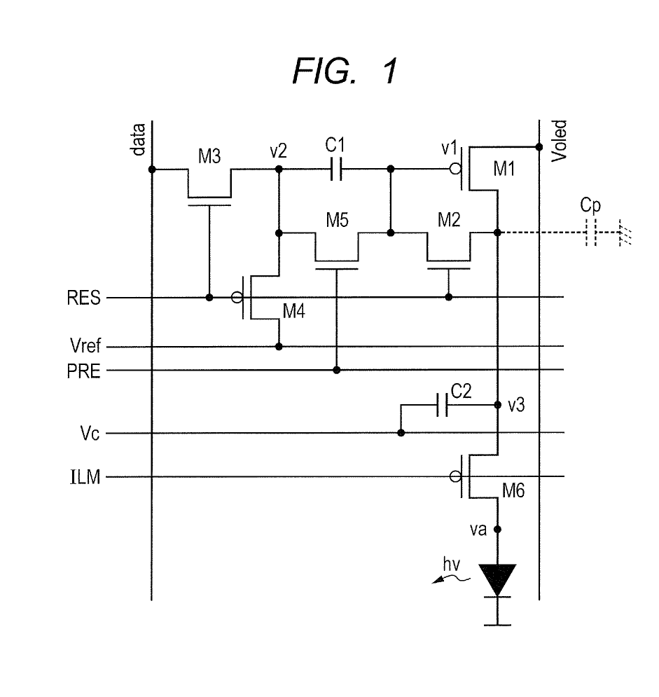

FIG. 1 is a diagram illustrating an example of a driving circuit which is used in the invention.

A driving transistor (hereinbelow, also referred to as “driving Tr”) M1 supplies a current to a first electrode of a light emitting element having the first electrode (not shown) and a second electrode (not shown), thereby allowing the light emitting element to emit light at a luminance according to a magnitude of the current flowing between the first and second electrodes. A light emission controlling transistor M6 is arranged between the driving Tr and the first electrode and controls an electrical conduction between the driving Tr and the first electrode. Switching transistors M2 to M5 are provided. In FIG. 1, the driving transistors M1 and M6 are of the P type and the driving transistors M2 to M5 are of the N type. However, M1 and M6 may be of the N type and M2 to M5 may be of the P type.

A capacitor C1 is provided to hold a gate voltage of the driving transistor. A capacitor C2 is provided to drop a voltage of a parasitic capacitor Cp which a node (terminal) of the driving Tr at a side of the light emitting element. One terminal of the capacitor C2 is connected to the node of the driving Tr at the side of the light emitting element and the other terminal is connected to a control signal line Vc.

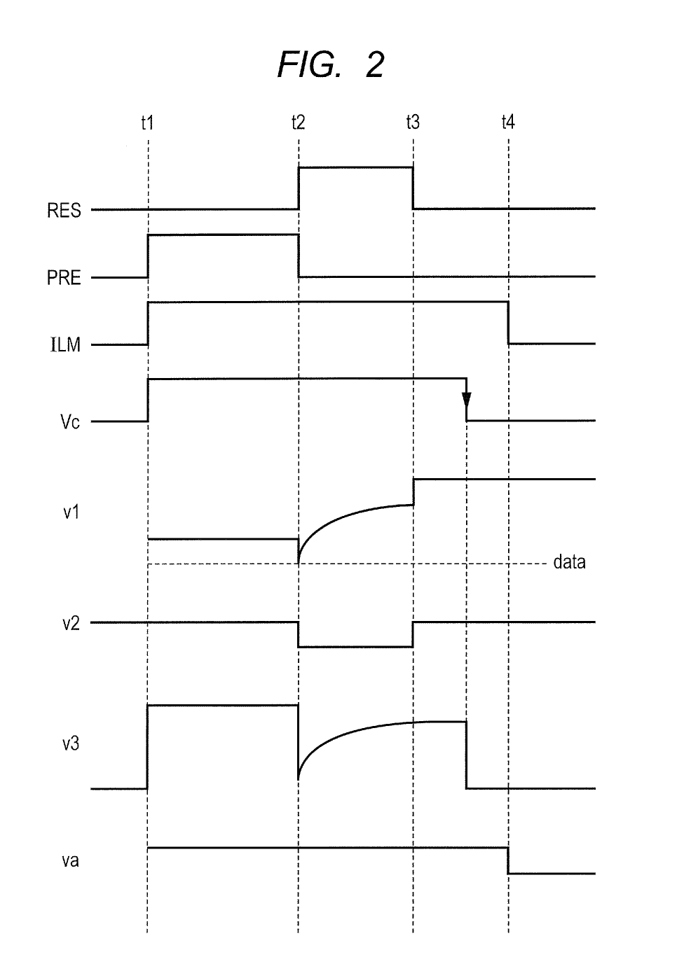

FIG. 2 is a timing chart showing the operation of the driving circuit in FIG. 1.

For a period of time between time t1 and time t2, a scanning signal PRE is at the high level (PRE=H), a scanning signal RES is at the low level (RES=L), a scanning signal ILM is at the high level (ILM=H), M4 and M5 are turned on, and M2, M3, and M6 are turned off, respectively. For this period of time, the gate of the driving Tr, that is, a voltage (v1) at one terminal of the capacitor C1 and a voltage (v2) at the other terminal of the capacitor C1 are set to a reference voltage Vref. A node voltage (v3) of the driving Tr at the side of the light emitting element is set to a voltage Voled. A voltage (Va) of the first electrode is almost equal to a voltage of the second electrode, so that no current flows into the light emitting element.

At time t2, the scanning signal PRE=L, the scanning signal RES=H, M2 and M3 are turned on, and M4 and M5 are turned off, respectively. Since ILM=H, M6 is held in the off state.

For this period of time, since the other terminal of the capacitor C1 and a data line are connected, a voltage according to a light emitting luminance of the light emitting element is set into the gate of the driving Tr and the v2 voltage is equal to a data line voltage Vdata. The v1 voltage changes by an amount corresponding to a difference between the reference voltage Vref and the data line voltage Vdata at time t2.

Since the gate and a drain of the driving Tr are connected, for a period of time between time t2 and time t3, the capacitor C1 is charged by a drain current (driving current) of the driving Tr according to a voltage (Vgs) between the gate and a source of the driving Tr, so that the v1 voltage rises. In association with the increase in v1 voltage, the drain current of the driving Tr also decreases. When the drain current of the driving Tr is equal to zero, that is, when v1 is equal to a threshold voltage (Vth) of the driving Tr (v1=Vth), the voltage rising stops. At this time, a voltage difference ΔVc across the capacitor C1 is equal to [ΔVc=(Voled−Vth)−Vdata].

At time t3, the scanning signal PRE=L, RES=L, M4 is turned on, and M2, M3, and M5 are turned off, respectively. Since ILM=H, M6 is held in the off state. At this time, the v1 voltage is

v1=Vref±Vc.

Vgs of the driving Tr is

Vgs=Vdata−Vref+Vth.

Thus, the voltage adapted to decide the light emitting luminance is set into the gate of the driving Tr.

Since a drain current Id of the driving Tr is

Id=β(Vgs−Vth)²,

Id=β(Vdata−Vref)².

From the right side of the above equation, the term of the threshold voltage of the driving Tr is eliminated. Therefore, the driving current which is not influenced by a Vth variation can be supplied to the EL.

From time t1, the voltage of the control signal Vc is held at H. For a period of time between time t3 and time t4, the control signal Vc is supplied to the other terminal of the capacitor C2 in such a manner that it changes from H to L, that is, changes in a direction toward the voltage of the second electrode.

At time t4, the scanning signal PRE=L, RES=L, ILM=L, M4 and M6 are turned on, and M2, M3, and M5 are turned off, respectively.

When M6 is turned on at time t4, the drain current Id is supplied from the driving Tr.

The parasitic capacitor Cp is necessarily formed when the transistor or wirings are formed. For example, it is a parasitic capacitor connected to the drain of the driving Tr. A capacitance of the parasitic capacitor Cp is equal to the sum of a capacitance between the gate and the source (or drain) of each of the driving Tr M2 and M6 and, if there are wirings which cross their connection wirings, a capacitance Cw between their wiring layers. The capacitance between the gate and the source (or drain) can be obtained by measuring C-V characteristics between the gate and the source (or drain) by using a semiconductor parameter analyzer or the like in a transistor process which is used. The capacitance Cw between the wirings is obtained as follows when assuming that an area where the wirings cross is set to S, a distance between the wirings is set to d, and a dielectric constant of an insulating layer between the wirings is set to ∈, respectively.

Cw=∈·(S/d)

When the gradation data=0, that is, at the time of a black displaying, the drain voltage of the driving Tr is set to Voled−Vth at time t3 and the following electric charges are accumulated into the parasitic capacitor Cp and the capacitor C2.

Q(Cp+C2)=(Cp+C2)×(Voled−Vth)

In this state, those electric charges flow into the EL at time t4 and the EL which should inherently performs the black displaying instantaneously emits light.

However, if the control signal Vc which changes from H to L as mentioned above is supplied to the other terminal of the capacitor C2 until the timing before the start of the light emission at time t4, the v3 voltage decreases. Such a situation that when M6 is set into an electrically conducting state, the electric charges Q(Cp+C2) flow into the EL can be prevented.

In order to certainly prevent the electric charges Q(Cp+C2) from flowing into the EL, it is necessary to set the v3 voltage to a value which is equal to or lower than a threshold voltage for initiating the light emission of the EL. In order to realize such a state, it is necessary to set the electric charges Q(C2) which are reduced in the capacitor C2 to a predetermined amount or more. Such an amount can be calculated. There is the following relation among them.

Q(C2)=C2×ΔVc≧(Cp+C2)×(Voled−Vth)

where, ΔVc denotes an amplitude of the control signal Vc. Therefore, if a capacitance value of the capacitor C2 to be set satisfies the following relational expressions:

C2/(Cp+C2)≧(Voled−Vth)/ΔVc and

C2≧Cp/[{ΔVc/(Voled−Vth)}−1],

such a situation that the electric charges in the parasitic capacitor Cp and the capacitor C2 which were charged during the writing operation flow into the EL can be certainly prevented.

When a threshold voltage (ELVth) for initiating the light emission of the EL is not equal to zero, it is sufficient to satisfy the following relational expression.

C2≧Cp/[{ΔVc/(Voled−Vth−ELVth)}−1]

where, the threshold voltage for initiating the light emission of the EL is a voltage applied between a first electrode and a second electrode of the light emitting element which provides a black luminance that is determined by a contrast specification of a displaying apparatus. For example, the black luminance is equal to 0.01 cd/m² at a light emitting duty of 100% when assuming that the contrast specification of the displaying apparatus which emits light at 500 cd/m² at the time of all white displaying is equal to 50000:1.

The capacitor C2 can be constructed in such a manner that an electro-conductive layer forming the control signal line Vc and a semiconductor layer forming the drain of the driving Tr or a terminal of another transistor connected thereto are formed so as to face through an insulating layer. It may be formed by a construction in which the electro-conductive layer forming the control signal line Vc and an electro-conductive layer connected to the drain of the driving Tr are formed through the insulating layer.

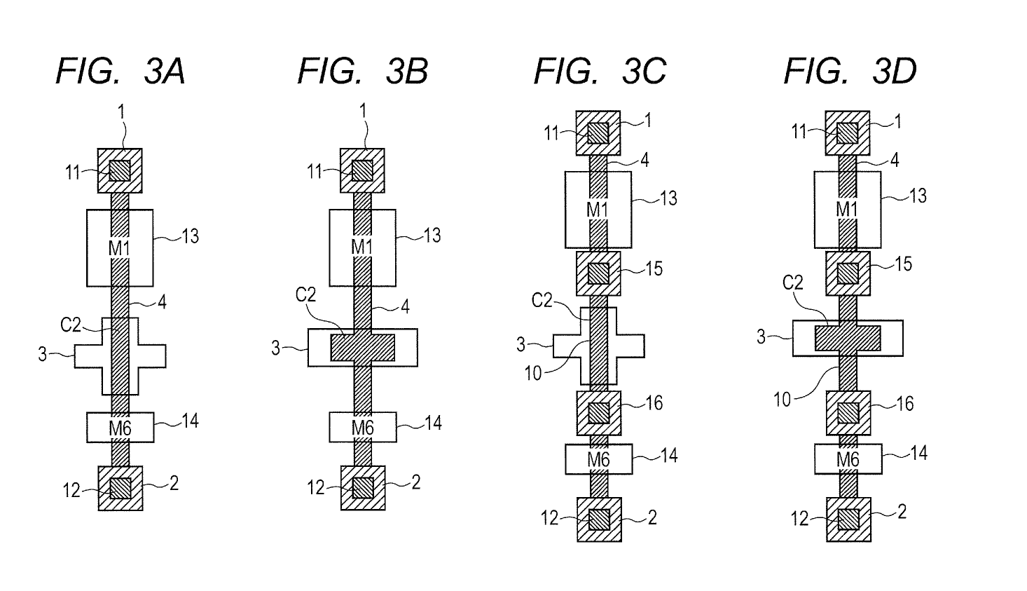

FIG. 3A is a diagram illustrating a shape of the control signal line Vc and the capacitor C2 which is formed by a semiconductor layer. A semiconductor layer 4 is connected to another electro-conductive layer by contact pads 1 and 2 through contact holes 11 and 12 formed in an insulating layer. Between the contact pads 1 and 2, the semiconductor layer 4 overlaps gate wirings 13 and 14 and forms the transistors M1 and M6, respectively.

Between the transistors M1 and M6, the semiconductor layer 4 overlaps a control signal line 3 and the capacitor C2 is formed. In a portion where it overlaps the semiconductor layer 4, a width of the control signal line 3 is wide so that the capacitor C2 has a design capacitance value.

As illustrated in FIG. 3B, in a crossing portion, a width of the semiconductor layer 4 may be widened without changing the width of the control signal line 3.

In the semiconductor layer forming the capacitor C2, an electric conductivity may be raised by increasing an ion dope amount to a value larger than that in a portion where a channel is formed.

In FIGS. 3C and 3D, the capacitor C2 is formed in an overlapping portion of the control signal line 3 and an electro-conductive layer 10 formed in another layer. The electro-conductive layer 10 is a wiring connecting one contact pad 15 of the transistor M1 and one contact pad 16 of the transistor M6. In a manner similar to FIG. 3A, FIG. 3C illustrates such a construction that the width of the control signal line 3 is widened in a crossing portion, thereby enabling the capacitor C2 having a predetermined capacitance value to be obtained. In a manner similar to FIG. 3B, FIG. 3D illustrates such a construction that the width of the electro-conductive layer 10 is widened in a crossing portion, thereby enabling the capacitor C2 having a predetermined capacitance value to be obtained.

As for the capacitor C2, in order to satisfy the foregoing relational expressions, as illustrated in FIGS. 3A and 3B, the width of the electro-conductive layer in the crossing portion may be set to a value wider than a width of the electro-conductive layer of a scanning line which does not cross the semiconductor layer, or a width of the semiconductor layer which crosses the electro-conductive layer may be set to a value wider than a width of a wiring portion of the semiconductor layer which does not cross the electro-conductive layer. As illustrated in FIGS. 3C and 3D, the semiconductor layer which forms the capacitor C2 may be a second electro-conductive layer.

### Embodiment 1

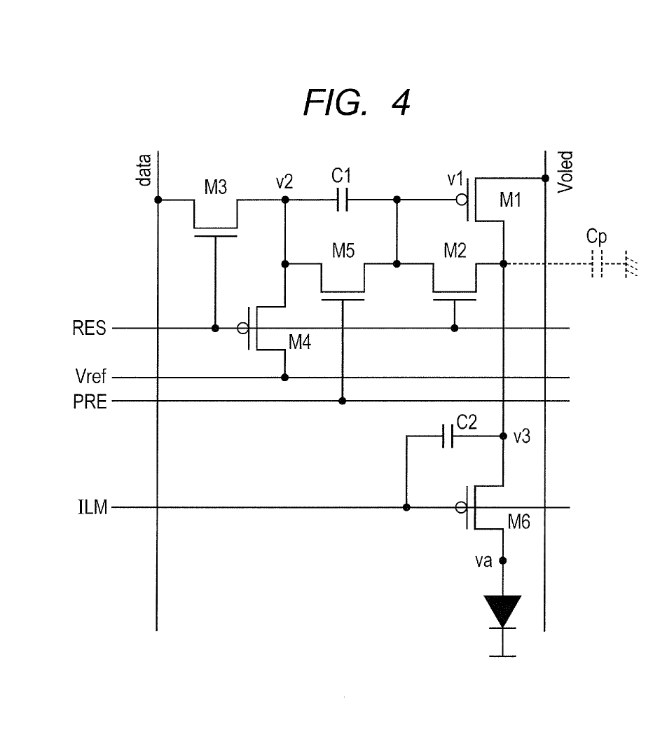

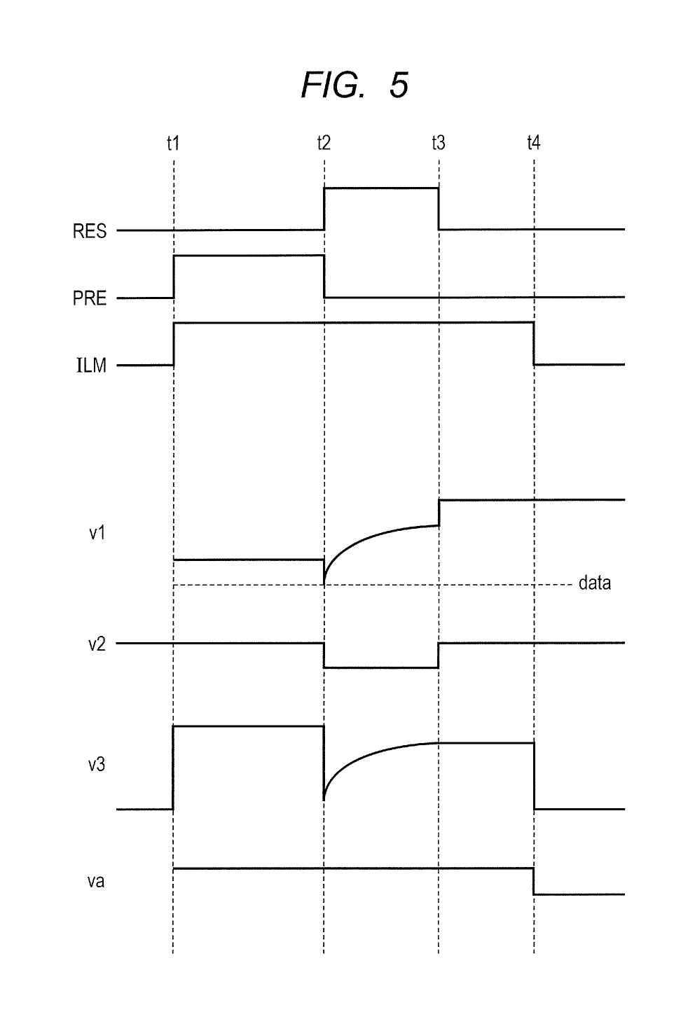

In the embodiment, the apparatus is driven by using a driving circuit in FIG. 4 in accordance with a timing chart of FIG. 5.

The driving circuit in FIG. 4 differs from the driving circuit in FIG. 1 with respect to a point that the scanning signal ILM is supplied in place of supplying the control signal Vc. Since there is no need to provide a wiring of the control signal line for supplying the control signal Vc, it is desirable in terms of a point that the light emitting element can be microminiaturized.

At time t4, the scanning signal ILM changes from H to L. In order to set the drain voltage (v3) of the driving transistor to a value which is equal to or lower than the threshold voltage for initiating the light emission of the EL, the capacitance value of the capacitor C2 is set to a value which satisfies the following condition when assuming that the amplitude of the scanning signal ILM is equal to ΔVilm.

C2≧Cp/[{ΔVilm/(Voled−Vth−ELVth)}−1]

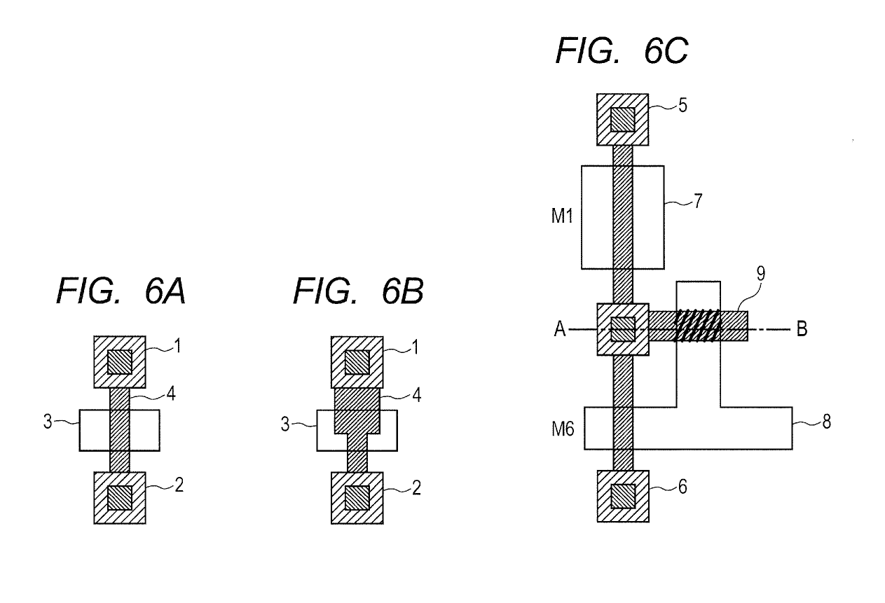

A forming method of the capacitor C2 in the embodiment is illustrated in FIGS. 6A to 6C.

FIG. 6A illustrates a construction of the normal transistor M1 or M6. The contact pad 1 serving as a drain terminal, the contact pad 2 serving as a source terminal, the electro-conductive layer 3 which forms a gate, and the semiconductor layer 4 are provided.

FIG. 6B illustrates such a construction that a gate width of the transistor at the source side and that of the transistor at the drain side are made different, thereby forming the capacitor C2. If a channel width of the transistor at the drain side is set to be wider than that in a normal case and a capacitance value between the gate and the drain is increased, an increase amount from FIG. 6A results in the capacitor C2.

In FIG. 6C, the contact pad 15 of the drain terminal of the transistor M1 and the contact pad 16 of the source terminal of the transistor M6 are common and a semiconductor layer 9 extending therefrom is made to cross an ILM signal line 8 (electro-conductive layer which forms a gate), thereby forming the capacitor C2.

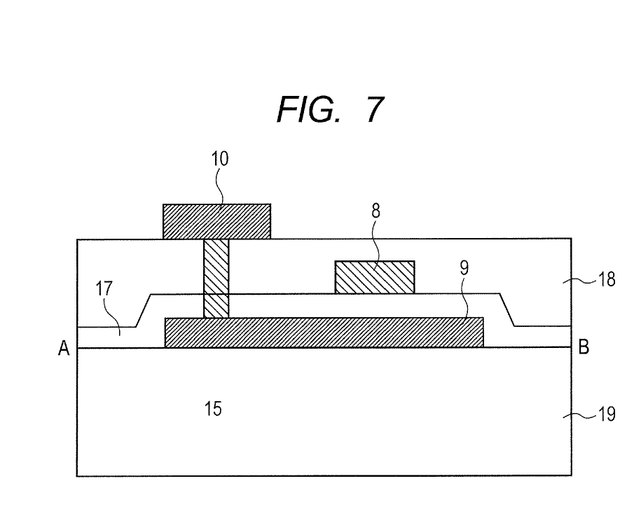

FIG. 7 is a diagram illustrating a cross section taken along the line A-B in FIG. 6C. The semiconductor layer 9 extending from the common contact pad 15 overlaps the ILM signal line 8, thereby forming the capacitor C2. The semiconductor layer 9 faces the ILM signal line 8 through a gate insulating layer 17 formed on the semiconductor layer 9. The common contact pad 15 is connected to the electro-conductive layer 10 through a contact hole formed in the gate insulating layer 17 and an interlayer insulating layer 18 formed thereon.

As mentioned above, the capacitor C2 can be constructed by a capacitor between the gate and the drain of M6. In the construction as illustrated in FIG. 6A, not only the capacitance between the gate and the drain of M6 but also a capacitance between the gate and a source of M6 increase. The scanning signal ILM changes from L to H at timing when the EL is switched from a light emitting mode to a non-light emitting mode. At this time, an EL voltage (va) rises and the EL emits light. Therefore, in the case of forming the capacitor C2 by the capacitor between the gate and the drain of M6, it is necessary to set the capacitance between the gate and the source to a value smaller than the capacitance between the gate and the drain.

When the scanning signal ILM changes from L to H, the drain voltage (v3) of the driving Tr rises by the capacitance C2 and the capacitance between the gate and the drain. However, since an ILM switch is turned off during the transition from L to H, even if the drain voltage (v3) of the driving Tr rises, the light emission of the EL can be prevented.

According to the embodiment mentioned above, since the capacitance C2 is provided, such a situation that the electric charges Q(Cp+C2) accumulated in the parasitic capacitor Cp which the drain of the driving Tr has and the capacitor C2 flow into the EL can be prevented.

Although the driving circuit for compensating the threshold voltage of the driving Tr has been shown as an example in the embodiment, the effects of the invention are obtained even by a construction of the driving circuit other than the construction of the embodiment so long as it has such a construction that the driving Tr and M6 are serially connected, the current is shut off by M6, and the drain voltage of the driving Tr rises.

### Embodiment 2

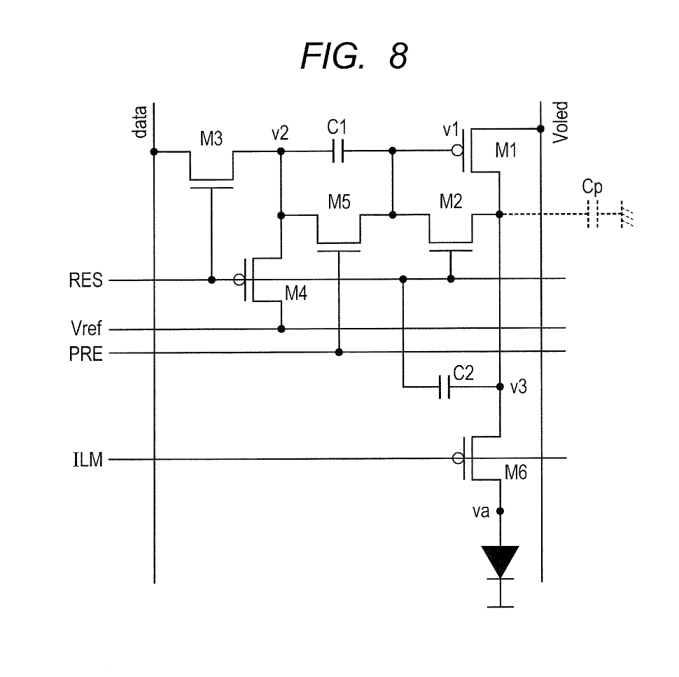

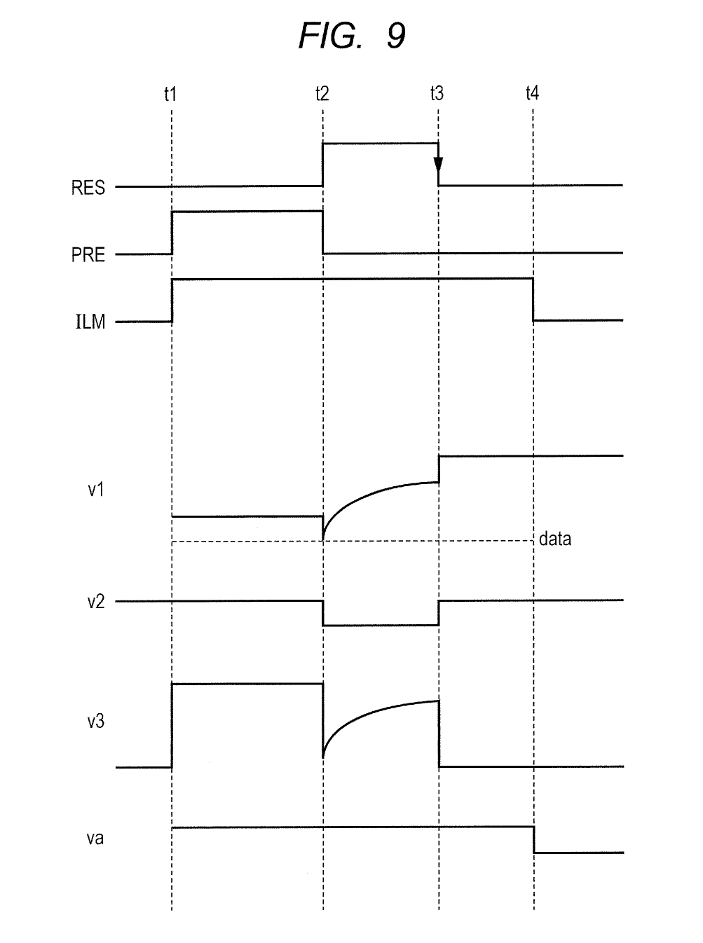

In this embodiment, the apparatus is driven by using a driving circuit in FIG. 8 in accordance with a timing chart of FIG. 9.

The driving circuit in FIG. 8 differs from the driving circuit in FIG. 1 with respect to a point that the scanning signal RES is supplied in place of supplying the control signal Vc. Since there is no need to provide a wiring of the control signal line for supplying the control signal Vc, it is desirable in terms of a point that the light emitting element can be microminiaturized.

At time t3, the scanning signal RES changes from H to L. In order to set the drain voltage (v3) of the driving transistor to a value which is equal to or lower than the threshold voltage for initiating the light emission of the EL, the capacitance value of the capacitor C2 is set to a value which satisfies the following condition when assuming that the amplitude of the scanning signal RES is equal to ΔVres.

C2≧Cp/[{ΔVres/(Voled−Vth−ELVth)}−1]

As a forming method of the capacitor C2 in the embodiment, the capacitor C2 can be formed by forming a capacitor in a crossing portion of the wiring connected to the drain of the driving Tr and the wiring of the scanning line for supplying the scanning signal RES.

For a period of time between time t3 and time t4, the drain voltage (v3) of the driving Tr enters a floating state. In the black displaying, the voltage Vgs has been written into the driving Tr in a state where no current is supplied. Therefore, the voltage at time t3 is held.

As for the scanning line to which the capacitor C2 is connected, it is sufficient that the electric charges charged in the parasitic capacitor Cp of the drain of the driving Tr are discharged until the start of the light emission after completion of the writing and the drain voltage (v3) of the driving Tr is set to a value which is equal to or lower than the threshold voltage for initiating the light emission of the EL. Therefore, also in a circuit construction other than FIG. 8, it is sufficient that trailing timing of the scanning line to which the capacitor C2 is connected lies within a period of time between time t3 serving as timing for finishing the writing as shown in FIG. 9 and time t4 serving as timing for initiating the light emission.

According to the foregoing embodiment, since the capacitor C2 is provided, in a manner similar to the embodiment 1, such a situation that the electric charges Q(Cp+C2) accumulated in the parasitic capacitor Cp which the drain of the driving Tr has and the capacitor C2 flow into the EL can be prevented.

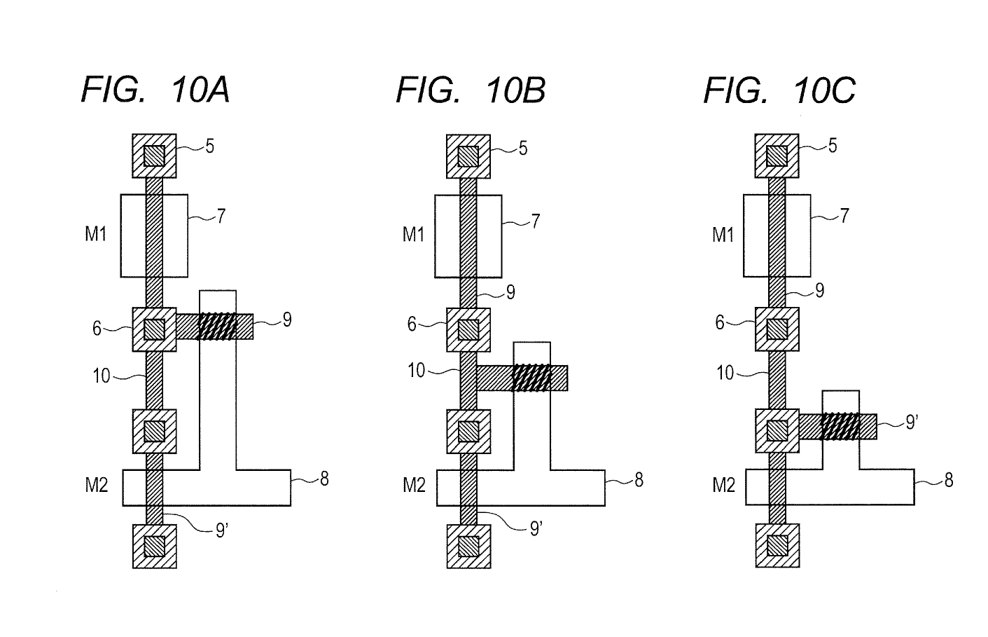

A forming method of the capacitor C2 is illustrated in FIGS. 10A to 10C.

Since polarities of the transistors M1 and M2 differ here, the transistors are formed in regions of the different semiconductor layers. Those two semiconductor layers are electrically connected by the second electro-conductive layer 10 through the contact hole so as to have the same voltage. As illustrated in FIG. 10A, by increasing the semiconductor layer 9 of the transistor M1 and forming a capacitor into a crossing portion (hatched portion in FIG. 10A) with the electro-conductive layer 8 where the gate is formed, the capacitor C2 can be formed. Similarly, as illustrated in FIG. 10C, by increasing a semiconductor layer 9′ of the transistor M2 and forming a capacitor into a crossing portion (hatched portion in FIG. 10C) with the electro-conductive layer 8 where the gate is formed, the capacitor C2 can be formed. Also, as illustrated in FIG. 10B, by increasing the second electro-conductive layer 10 and forming a capacitor into a crossing portion (hatched portion in FIG. 10B) with the electro-conductive layer 8 where the gate is formed, the capacitor C2 can be formed. An insulating layer is formed between the second electro-conductive layer 10 and the electro-conductive layer 8 where the gate is formed.

An information processing apparatus can be constructed by using the light emitting element having the driving circuit with the foregoing construction. The information processing apparatus has a form of one of a cellular phone, a portable computer, a digital still camera, and a video camera or is an apparatus for realizing a plurality of ones of their functions.

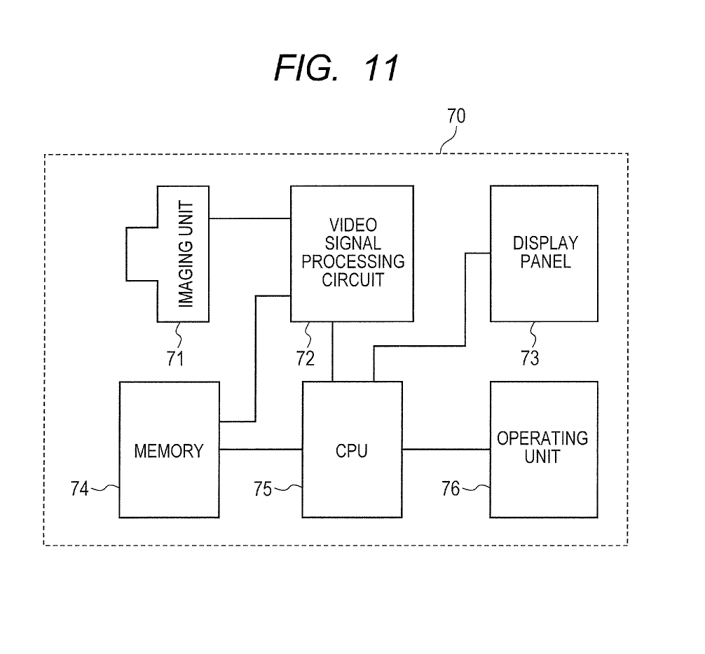

FIG. 11 is a block diagram of an example of a digital still camera. A digital still camera 70 has an imaging unit 71, a video signal processing unit 72, a display panel 73, a memory 74, a CPU 75, and an operating unit 76. A video image photographed by the imaging unit 71 or a video image recorded in the memory 74 is signal-processed by the video signal processing unit 72 and can be seen by the display panel 73. The CPU 75 controls the imaging unit 71, memory 74, video signal processing unit 72, and the like on the basis of an input from the operating unit 76 and executes the photographing, recording, reproduction, or displaying suitable for a situation. The display panel 73 can be also used as a display unit of various kinds of electronic apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-073919, filed Mar. 28, 2012, which is hereby incorporated by reference herein in its entirety.

What is claimed is:

1. A light emitting apparatus comprising:
a light emitting element having first and second electrodes, and emitting light by allowing a current to flow between the first and second electrodes;
a driving transistor for supplying the current to the first electrode;
a light emission controlling transistor arranged between the driving transistor and the first electrode, for controlling an electrical conduction between the driving transistor and the first electrode; and
a capacitor having one terminal connected to a terminal of the driving transistor at a side of the light emitting element, wherein
during a period after setting a voltage to be applied to a gate of the driving transistor according to a light emitting luminance of the light emitting element, until setting the light emission controlling transistor at an electrically conducting state, the other terminal of the capacitor is supplied with a control signal of which a voltage changes toward a voltage of the second electrode, and
the capacitor is constructed in such a manner that
an electro-conductive layer supplied with the control signal and
a semiconductor layer forming the terminal of the driving transistor at the side of the light emitting element, a semiconductor layer forming a terminal of a transistor different from the driving transistor and connected to the terminal of the driving transistor at the side of the light emitting element, or an electro-conductive layer connected to the terminal of the driving transistor at the side of the light emitting element
are formed so as to face through an insulating layer.

2. The light emitting apparatus according to claim 1, wherein
the control signal is supplied to a gate of the transistor different from the driving transistor and connected to the terminal of the driving transistor at the side of the light emitting element.

3. The light emitting apparatus according to claim 2, wherein
the driving transistor has a polarity different from a polarity of the transistor different from the driving transistor and connected to the terminal of the driving transistor at the side of the light emitting element.

4. The light emitting apparatus according to claim 1, wherein
the control signal is connected to a gate of the light emission controlling transistor.

5. The light emitting apparatus according to claim 4, wherein
the light emission controlling transistor has the same polarity as that of the driving transistor.

6. The light emitting apparatus according to claim 2, wherein
a width of the gate at a source side and a width of the gate at a drain side of the transistor different from the driving transistor are different.

7. The light emitting apparatus according to claim 1, wherein
a width of the electro-conductive layer supplied with the control signal is larger at a part thereof forming the capacitor rather than that at the other part thereof.

8. The light emitting apparatus according to claim 1, wherein
a width of the semiconductor layer forming the terminal of the driving transistor at the side of the light emitting element, or the semiconductor layer forming a terminal of a transistor different from the driving transistor and connected to the terminal of the driving transistor at the side of the light emitting element is larger at a part thereof forming the capacitor rather than that at the other part thereof.

9. The light emitting apparatus according to claim 1, wherein
a width of the electro-conductive layer connected to the terminal of the driving transistor at the side of the light emitting element is larger at a part thereof forming the capacitor rather than that at the other part thereof.

10. The light emitting apparatus according to claim 1, wherein
when a capacitance of the capacitor is C2 and a parasitic capacitance of the driving transistor connected to the terminal of the driving transistor at the side of the light emitting element other than the capacitor is Cp, a following relation is met:
C2×(an amplitude of the control signal)≧(Cp+C2)×((the voltage of the terminal of the driving transistor at the side of the light emitting element)−(a threshold voltage for initiating the light emission from the light emitting element)).

11. A driving method of a light emitting apparatus comprising:
a light emitting element having first and second electrodes, and emitting light by allowing a current to flow between the first and second electrodes;
a driving transistor for supplying the current to the first electrode;
a light emission controlling transistor arranged between the driving transistor and the first electrode, for controlling an electrical conduction between the driving transistor and the first electrode; and
a capacitor having one terminal connected to a terminal of the driving transistor at a side of the light emitting element,
wherein the method comprises:
a first step of setting a voltage to be applied to a gate of the driving transistor according to a light emitting luminance of the light emitting element;
a second step of setting the light emission controlling transistor at an electrically conducting state; and,
after the first step until a start of the second step, supplying the other terminal of the capacitor with a control signal of which a voltage changes toward a voltage of the second electrode.
